(19) United States
(12) Patent Application Publication
(10) Pub. No.: US 2018/0080484 A1
(43) Pub. Date: Mar. 22, 2018

(54) Vortex Breaker With Dome Integration

(71) Applicant: OMG, Inc., Agawam, MA (US)

(72) Inventors: Arun Srinivasan Venkatesan, Feeding Hills, MA (US); Daniel L. Genovese, Westfield, MA (US); Tad A. Weiss, Westhampton, MA (US)

(21) Appl. No.: 15/705,968

(22) Filed: Sep. 15, 2017

Related U.S. Application Data
(60) Provisional application No. 62/397,599, filed on Sep. 21, 2016.

(51) Int. Cl. F15D 1/02; E04D 13/04

(52) U.S. Cl. CPC F15D 1/025; E04D 2013/0427; E04D 2013/0413; E04D 13/0409

(57) ABSTRACT

A vortex breaker and a drainage assembly with a plurality of fins extending radially outward from a common central axis to respective terminal edges. Each fin has an attachment member for cooperation with bars of a domed strainer installed over a drain inlet. Engagement of the attachment members and domed strainer rigidly fixes the vortex breaker relative to the domed strainer.

### CROSS-REFERENCE TO RELATED APPLICATION

This application is a non-provisional claiming priority to U.S. Provisional Patent Application No. 62/397,599 filed Sep. 21, 2016, the entire content of which is incorporated herein by reference in its entirety.

### BACKGROUND

The present disclosure relates to roofing drains. More particularly, the disclosure relates to a device for slowing or “breaking” a fluid vortex at the inlet of a roofing drain.

In a building structure, roofing drain systems are positioned at different locations around the roof for guiding rain water or fluid from melted snow and ice from an inlet through a conductor pipe. Typically an inner drain pipe is positioned within an outer conductor pipe with a fluid tight sealing member therebetween. Commonly a strainer or similar element is installed over the inlet to prevent debris from entering the drain. One style of strainer takes on a domed shape, for example, with a substantially frustoconical contour.

A common problem associated with such drain systems is the formation of a vortex at the inlet of the drain during periods of higher volume fluid flow. Inlet vortexes create a suction effect downstream in the drain, thereby reducing flow rate and overall drainage rate through the drain. Vortex breakers exist for reducing or preventing formation of a vortex at the inlet. Known vortex breakers are designed for use within specific drain systems and require mechanical attachment to the drain system by way of screws, clamps or other fasteners cooperating with other existing portions of the drain system. Without such fastener attachment, the vortex breaker would be unsecured and thus easily dislodged from working position via natural forces from fluid flow or wind, for example. Of course, any time fasteners are required for attachment, it carries extra installation steps and requires additional materials that are sometimes difficult to handle due to their small size. Additionally, on a general level, as more that fasteners are used in roofing systems, the greater the chances are of fluid leakage over time.

It would thus be useful to have a vortex breaker that can be rigidly secured to common roofing drain elements without requiring use of separate fasteners or drilling of holes into the roof drain components.

### SUMMARY

An embodiment of a vortex breaker for use in conjunction with a domed strainer, has a plurality of fins, each fin extending radially outward from a common central axis to a respective terminal edge. Each fin includes an attachment member for cooperation with the bars of the domed strainer to rigidly fix the vortex breaker to the domed strainer.

In one embodiment of the vortex breaker, the attachment members are defined by an outer surface of the fins that tapers outward from the top edges each respective fin.

In another embodiment of the vortex breaker, each of the attachment members comprises a projection extending outward from a fin proximate the fin terminal edge.

In yet another embodiment of the vortex breaker, each of the attachment members is a fork at the terminal edge of the respective fin. The fork comprises two spaced fingers that extend radially from the terminal edge of the fin.

In another embodiment, a drainage assembly includes a drain inlet, a domed strainer and a vortex breaker. The drain inlet leads to a drainage channel. The domed strainer is positioned around the inlet and defines an inner area. The vortex breaker is positioned over the inlet within the inner area of the domed strainer and is rigidly secured to the domed strainer via frictional engagement independent of fasteners.

### BRIEF DESCRIPTION OF THE DRAWINGS

FIG. 1 shows a first embodiment of a vortex breaker according to the disclosure;

FIG. 2 is another embodiment of a vortex breaker according to the disclosure;

FIG. 3 is another embodiment of a vortex breaker according to the disclosure;

FIG. 4 shows the embodiment of FIG. 1 installed above a drain;

FIG. 5 shows the embodiment of FIG. 2 installed above a drain; and

FIG. 6 shows the embodiment of FIG. 3 installed above a drain.

### DESCRIPTION OF THE PREFERRED EMBODIMENT

Among the benefits and improvements disclosed herein, other objects and advantages of the disclosed embodiments will become apparent from the following wherein like numerals represent like parts throughout the several figures. Detailed embodiments of a vortex breaker for use with a domed strainer and a drainage assembly are disclosed; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “In some embodiments” and “in some embodiments” as used herein do not necessarily refer to the same embodiment(s), though it may. The phrases “in another embodiment” and “in some other embodiments” as used herein do not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

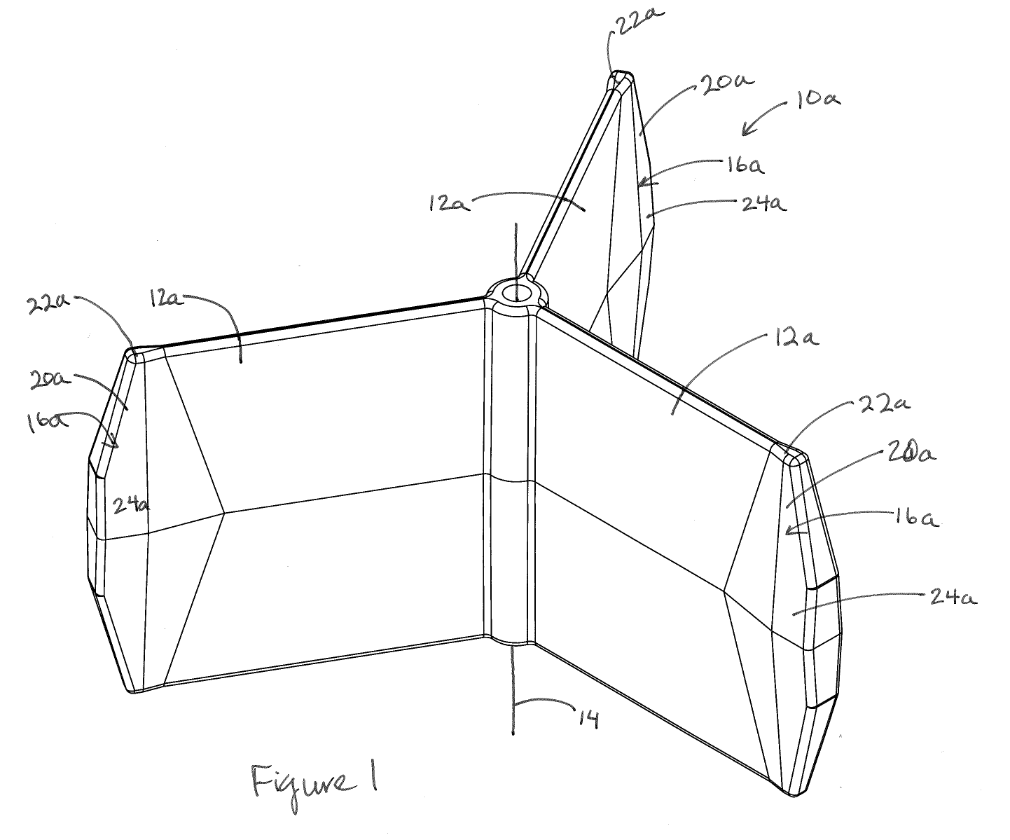

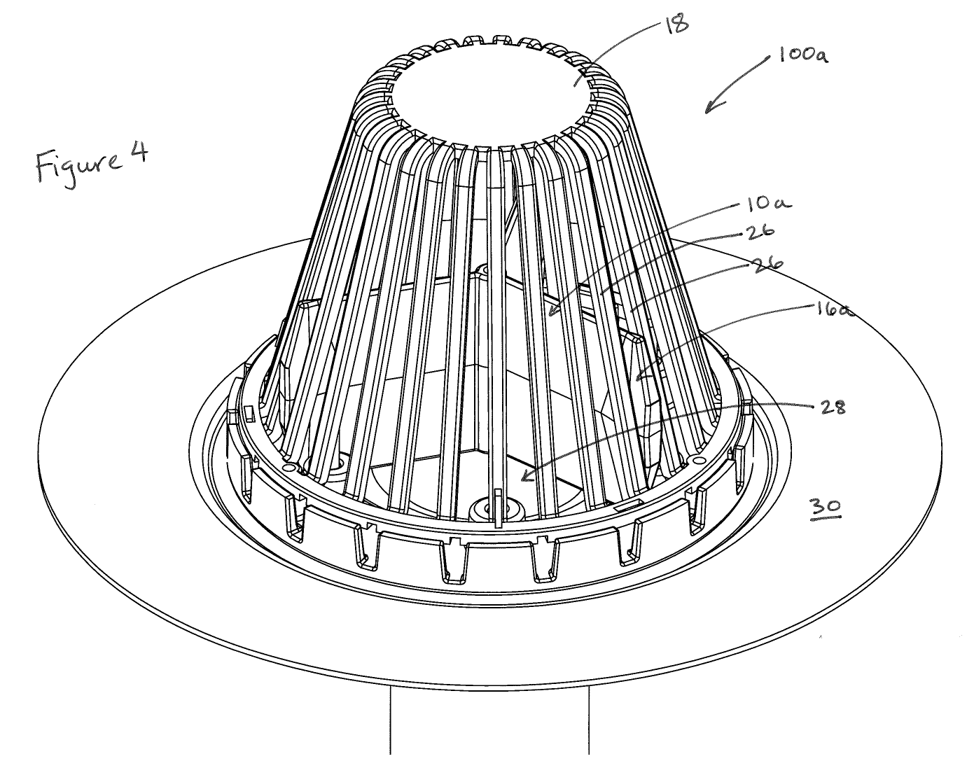

As shown in FIGS. 1-3, the inventive vortex breaker (10a, 10b, 10c) most generally comprises a plurality of fins (12a, 12b, 12c) extending radially from a central axis 14 to a terminal edge. The depicted embodiments include three fins spaced equiangularly around the axis, although embodiments exist with more than three fins. Each fin (12a, 12b, 12c) comprises an attachment member (16a, 16b, 16c) proximate the terminal end. As will be discussed in detail below, the attachment members (16a, 16b, 16c) are sized and shaped to cooperate with members of a domed strainer, like that depicted as reference numeral 18 in FIGS. 4-6, for securement without the use of a separate fastener or fasteners.

As shown in FIG. 1, a first embodiment of the vortex breaker 10a includes an attachment member 16a on each fin 12a that comprises a transitioned or flared outer surface 20a. The contour of the outer surface 20a transitions outward from the top edge 22a of each fin 12a to an intermediate portion 24a with a thickness that is greater than the thickness of the upper edge 22a.

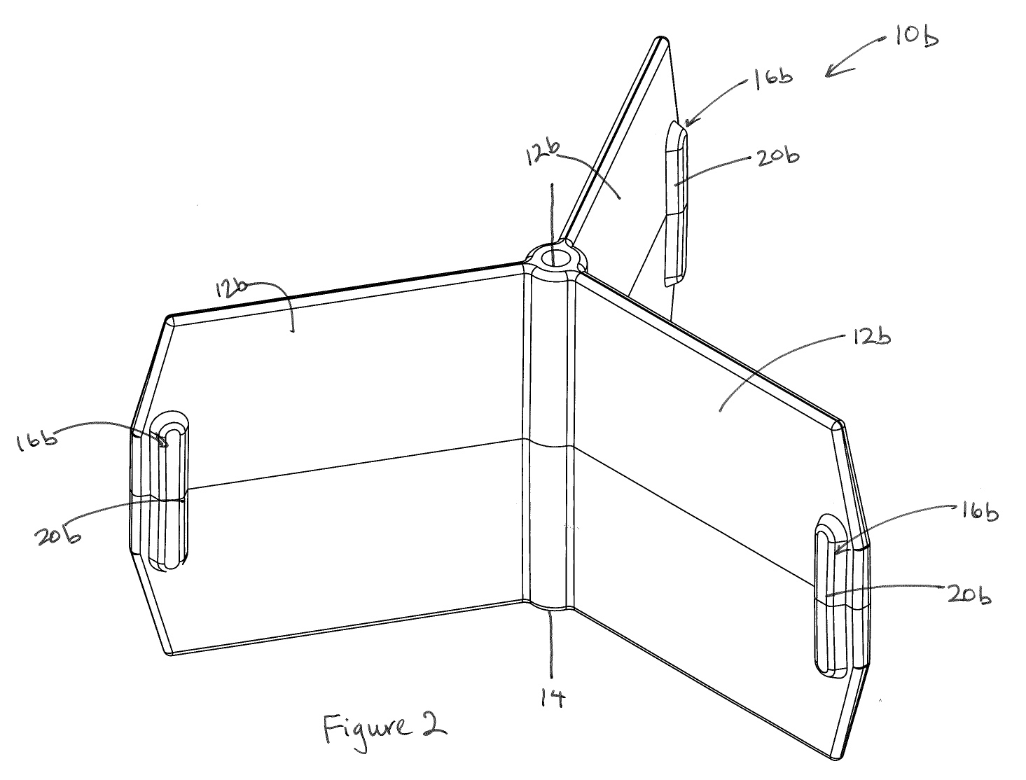

As shown in FIG. 2, another embodiment of the vortex breaker 10b includes an attachment member 16b on each fin 12b that comprises a pair of projections 20b extending from a surface on each fin 12b proximate the terminal end.

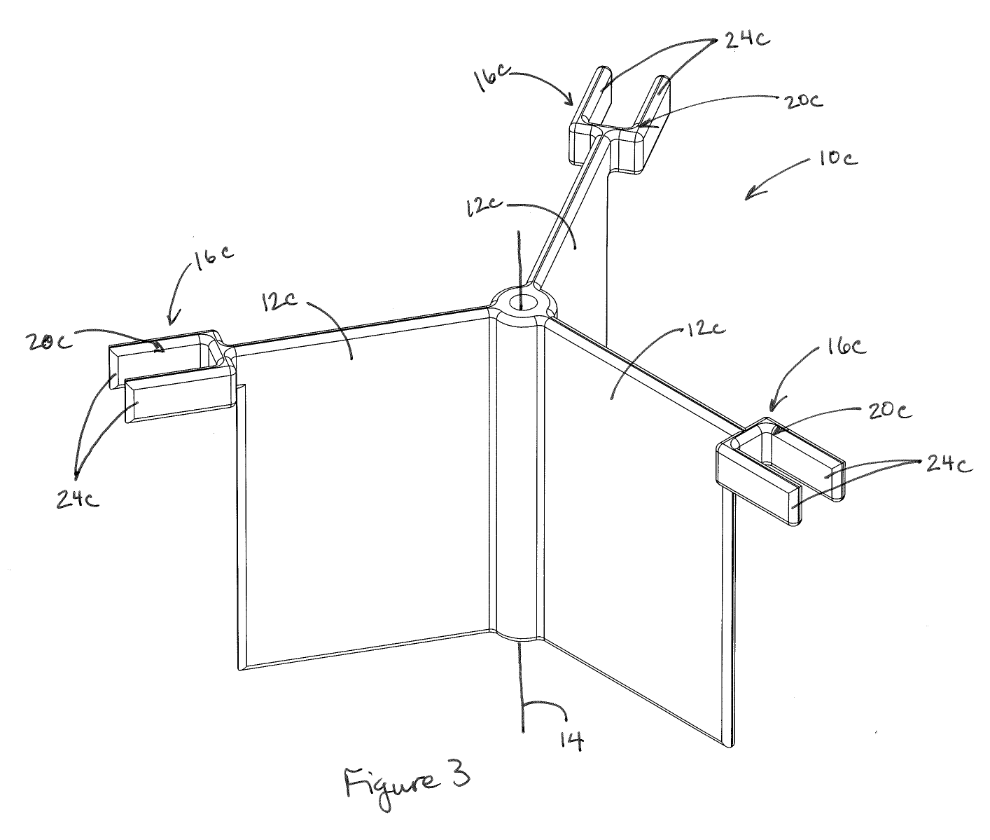

As shown in FIG. 3, another embodiment of the vortex breaker 10c includes an attachment member 16c on each fin 12c. Each of the attachment members 16c comprises a fork 20c on the respective fin 12c proximate the terminal edge. The fork includes a pair of fingers 24c spaced from one another and extending radially from the terminal edge of the fin 12c. The fingers 24c can form part of a U-shaped member, as depicted in FIG. 3.

FIGS. 4-6 depict the disclosed embodiments of the vortex breaker (10a, 10b, 10c) installed at the inlet 28 of a drainage system via engagement with a standard domed strainer 18. The strainer 18 is typically mechanically attached to the drain 30 via fasteners and the vortex breaker engages with the strainer 18 via cooperation of the attachment member (16a, 16b, 16c) and bars 26 of the strainer independent of the fasteners. The configuration of the attachment member and the frustoconical contour of the strainer 18 with bars that taper toward one another allows cooperation for a strong and rigid securement.

Specifically, with reference to FIG. 4, in the depicted assembly 100a, the embodiment of the vortex breaker 10a (i.e., the flared outer surface 20a) cooperates with the narrowing spaces between adjacent bars 26 to allow the attachment member to be wedged between the adjacent bars 26.

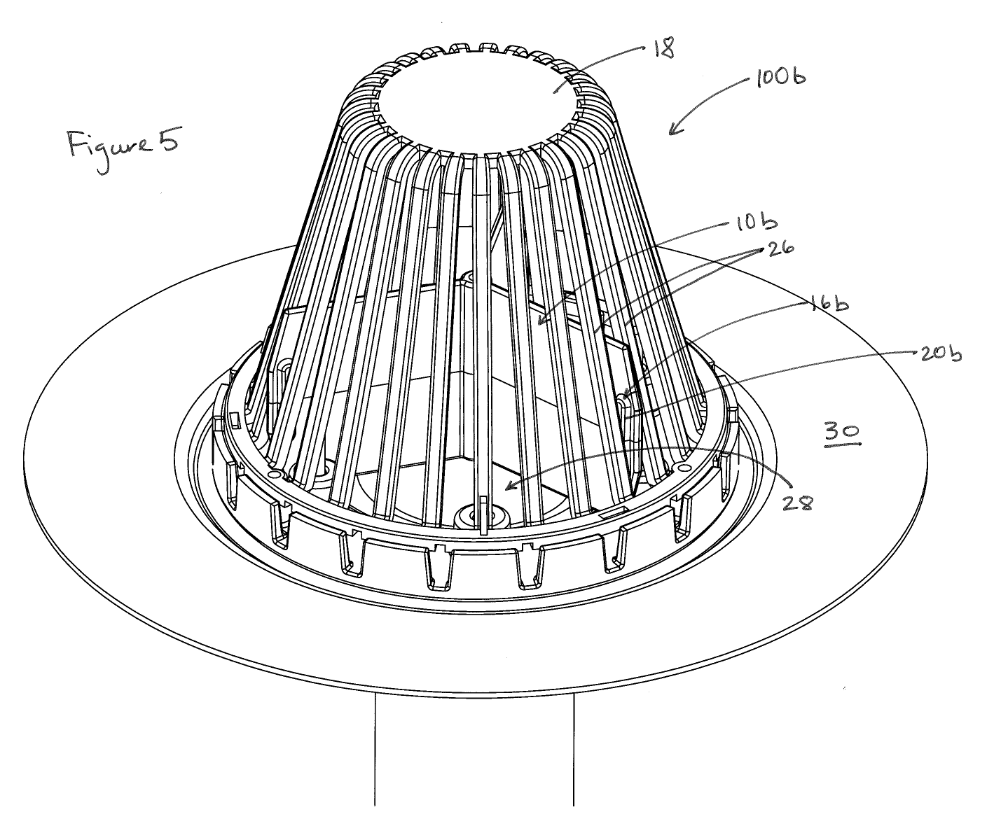

With reference to the assembly 100b of FIG. 5, the embodiment of the vortex breaker 10b engages with the strainer 18 in a similar manner as the vortex breaker 10a. The projections 20b are mechanically trapped between adjacent bars 26 to hold the vortex breaker in place relative to the strainer 18.

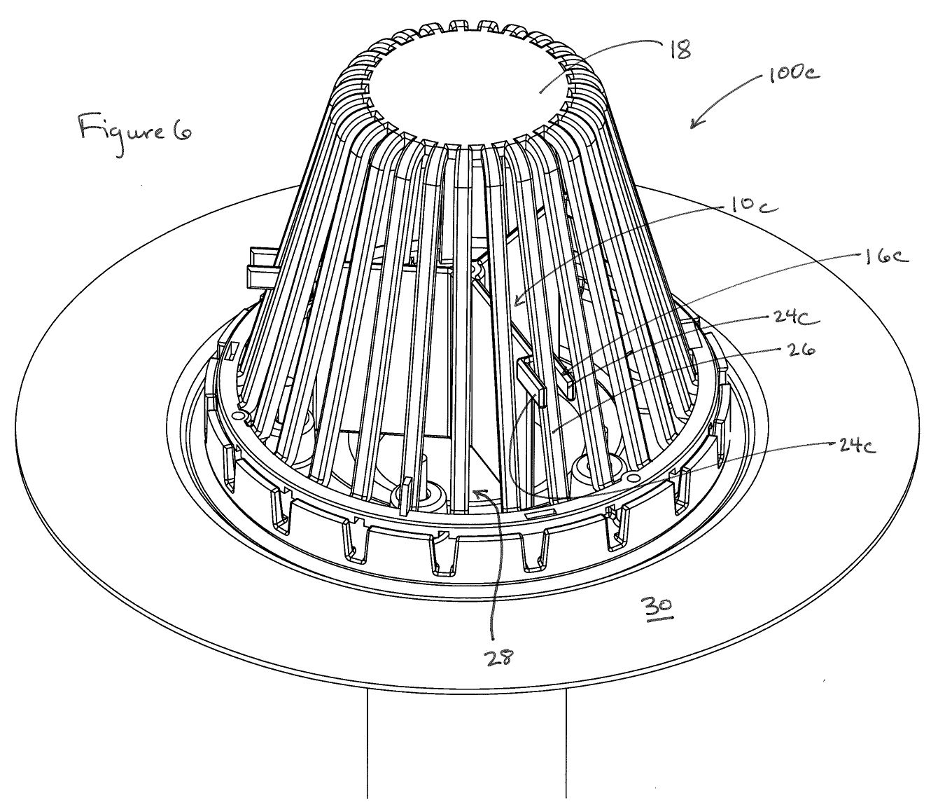

As shown in FIG. 6, in the assembly 100c, the embodiment of the vortex breaker 10c engages with the strainer 18 via trapping a single bar 26 between the spaced fingers 24c of the forks 20c.

In all of the above-described embodiments, the vortex breaker is maintained mechanically via engagement with the bars of the domed strainer, which also rotationally fixes the vortex breaker about the axis 14. Preferred embodiments of the disclosed vortex breaker (10a, 10b, 10c) are formed from a rigid resilient material, such as a plastic or metal.

Altogether, the disclosed embodiments of the vortex breaker 10 provide a significant advantage over known vortex breakers that require mechanical attachment to the drainage system via a separate member, such as a fastener. The vortex breaker can be attached to existing installations without requiring additional parts and/or additional installation steps.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A vortex breaker for use in conjunction with a domed strainer, comprising:
a plurality of fins, each fin extending radially outward from a common central axis to a respective terminal edge, wherein each fin includes an attachment member for cooperation with the bars of the domed strainer to rigidly fix the vortex breaker to the domed strainer.

2. The vortex breaker of claim 1, wherein the cooperation of the attachment member and bars of the domed strainer rotationally fixes the vortex breaker about the axis.

3. The vortex breaker of claim 1, comprising three fins equiangularly spaced from one another about the axis.

4. The vortex breaker of claim 3, wherein each of the fins includes an attachment member for cooperation with bars of the domed strainer.

5. The vortex breaker of claim 4, wherein each of the attachment members on the fins is substantially identical.

6. The vortex breaker of claim 4, wherein the attachment members are independently selected from the group consisting of a tapered outer surface that tapers outward from the top edges of the fins, a projection extending outward from a fin proximate the fin terminal edge, and a fork at the terminal edge of the fin, the fork comprising two spaced fingers that extend radially from the terminal edge of the fin.

7. The vortex breaker of claim 1, wherein the attachment members are defined by an outer surface of the fins that tapers outward from the top edges of the fins.

8. The vortex breaker of claim 1, wherein the attachment members are each a projection extending outward from a fin proximate the fin terminal edge.

9. The vortex breaker of claim 1, wherein each attachment member is a fork at the terminal edge of the fin, the fork comprising two spaced fingers that extend radially from the terminal edge of the fin.

10. The vortex breaker of claim 9, wherein each fork is positioned proximate the top edge of the respective fin.

11. A drainage assembly with a vortex breaker, comprising:
a drain inlet leading to drainage channel;
a domed strainer positioned around the drain inlet and defining an inner area; and
a vortex breaker positioned over the inlet within the inner area of the domed strainer, the vortex breaker being rigidly attached to the domed strainer via engagement with the domed strainer independent of fasteners.

12. The drainage assembly of claim 11, wherein the domed strainer comprises a series of bars and the vortex breaker includes a plurality of attachment members, and the vortex breaker is rigidly attached to the domed strainer via frictional engagement between the attachment members and the bars.

13. The drainage assembly of claim 12, wherein the bars of the domed strainer are circumferentially spaced from one another.

14. The drainage assembly of claim 13, wherein the domed strainer has a substantially frustoconical shape.

15. The drainage assembly of claim 11, wherein the domed strainer has a substantially frustoconical shape.

16. The drainage assembly of claim 11, wherein the vortex breaker comprises a plurality of fins extending radially from a central axis, the fins being circumferentially spaced from one another.

17. The drainage assembly of claim 16, wherein domed strainer comprises a series of outer bars spaced from one another along the circumference and the vortex breaker is secured to the domed strainer via wedging a fin between adjacent bars.

18. The drainage assembly of claim 17, wherein the fins of the vortex breaker have an outer surface with a contour that transitions outward from proximate the top edge.

19. The drainage assembly of claim 17, wherein the vortex breaker comprises a projection extending outward from a fin surface proximate the fin terminal edge and the projection is wedged between adjacent bars.

20. The drainage assembly of claim 16, wherein the domed strainer comprises a series of outer bars spaced from one another along the circumference and the vortex breaker comprises a fork at the terminal edge of each fin engaged with a bar to maintain the vortex breaker in rigidly secured.
